(19) United States
(12) Patent Application Publication
(10) Pub. No.: US 2013/0227226 A1
(43) Pub. Date: Aug. 29, 2013

(54) ELECTRONIC DEVICE AND METHOD FOR DATA BACKUP

(71) Applicants: ZHEN-XING MA, Shenzhen City (CN); XIAN-KUI CHEN, Shenzhen City (CN); HAI-LI WANG, Shenzhen City (CN)

(72) Inventors: ZHEN-XING MA, Shenzhen City (CN); XIAN-KUI CHEN, Shenzhen City (CN); HAI-LI WANG, Shenzhen City (CN)

(73) Assignee: HON HAI PRECISION INDUSTRY CO., LTD., Tu-Cheng (TW)

(21) Appl. No.: 13/459,105

(22) Filed: Apr. 28, 2012

(30) Foreign Application Priority Data
Feb. 24, 2012 (CN) 201210043509.5

(51) Int. Cl. G06F 12/00

(52) U.S. Cl. 711/154; 711/E12.001

(57) ABSTRACT

An electronic device includes a processor, a first storage unit, and a second storage unit. The first storage unit stores data generated by the processor in real time. The processor checks amount of storage space in use of the first storage unit, compares the current amount of used storage space of the first storage unit checked this time with a previous amount of used storage space of the first storage unit checked previously to determine whether the current amount of used storage space is greater than the previous amount of used storage space, obtains data that was stored in the storage space of the first storage unit since the previous check if the current used storage space is greater than the previously used storage space, and stores the obtained data in the second storage unit after the data is obtained.

### BACKGROUND

1. Technical Field

The present disclosure relates to an electronic device with data backup function and a data backup method.

2. Description of Related Art

Generally, a server includes a Baseboard Management Controller (BMC), a number of sensors, and other elements, such as a mainboard, a fan, and so on. The BMC detects performance of the server, such as a mainboard voltage, a fan speed, temperatures of elements, through the sensors. If an element operates outside pre-determined ranges of parameters, the BMC generates a system event log (SEL) and stores the SEL to a SEL area which can be accessed by users. However, because the storage space of the SEL area is limited, and when the SEL is full, subsequent logs will either not be stored or previous logs are overwritten.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device for data backup in accordance with an exemplary embodiment.

FIG. 2 is a flowchart of a method for backing up data of the electronic device of FIG. 1.

### DETAILED DESCRIPTION

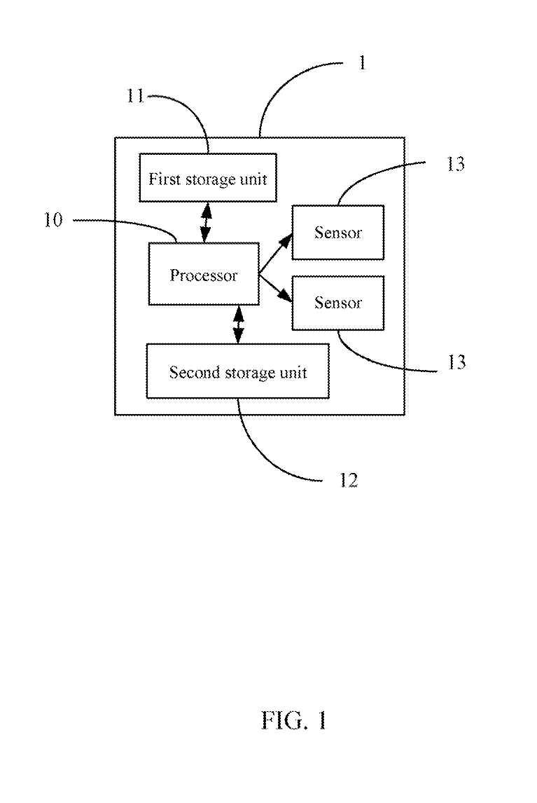

FIG. 1 is a block diagram of an electronic device 1 for data backup in accordance with an exemplary embodiment. The electronic device 1 includes a processor 10, a first storage unit 11, a second storage unit 12, a number of sensors 13, and other elements. In the embodiment, the electronic device 1 is a server and the processor 10 is a BMC. The BMC 10 detects abnormal states of the elements of the server 1, generates a SEL to record the abnormal state of the element, and stores the SEL to the first storage unit 11. In the embodiment, the second storage unit 12 is a hard disk of the server 1. In other embodiments, the second storage unit 12 can be external storage device such as a USB flash disk or a network storage. The storage space of the second storage unit 12 is greater than the storage space of the first storage unit 11.

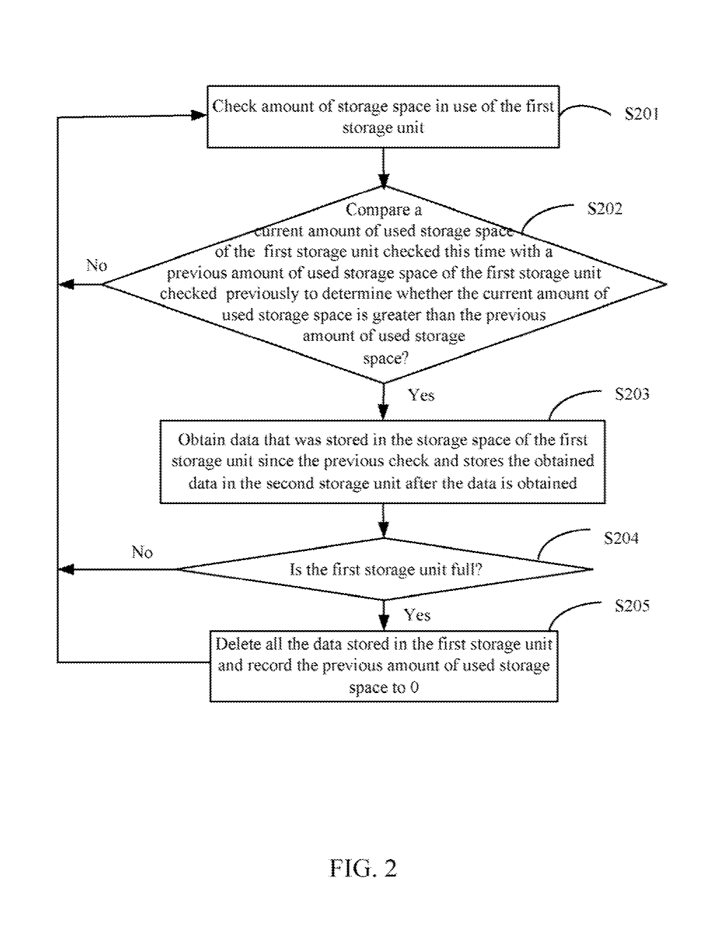

The processor 10 controls to back up the data stored in the first storage unit 11 to the second storage unit 12. The method for backing up the data stored in the first storage unit 11 to the second storage unit 12 is illustrated in FIG. 2.

In step S201, the processor 10 checks the amount of storage space in use of the first storage unit 11. In the embodiment, the amount of storage space in use of the first storage unit 11 is determined according to the number of the logs stored in the first storage unit 11.

In step S202, if step S201 has been performed previously, the processor 10 compares the current amount of used storage space of the first storage unit 11 checked this time with a previous amount of used storage space of the first storage unit checked previously to determine whether the current amount of used storage space is greater than the previous amount of used storage space. If the current amount of used storage space is not greater than the previous amount of used storage space, the procedure goes back to step S201. If the current used storage space is greater than the current used storage space, the procedure goes to step S203. If this is the first time step S201 has been performed, 0 is taken as the previous amount of used storage space.

In step S203, the processor 10 obtains the data that was stored in the storage space of the first storage unit 11 since the previous check.

In step S204, the processor 10 determines whether the first storage unit 11 is full. If the first storage unit 11 is not full, the procedure goes to step S202. If the first storage unit 11 is full, the procedure goes to step S205.

In step S205, the processor deletes all the data stored in the first storage unit 11 and records the previous amount of used storage space to 0.

In other embodiments, the data stored in the first data storage 11 are not limited to the SEL, the other real time data generated by the BMC 10 and stored in the first data storage 11 can also be backed up to the second data storage 12 using the method described above.

In the embodiment, one or more programs which the processor 10 implements may be embedded in firmware, such as in an erasable programmable read-only memory (EPROM) device.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising:
a processor;
a first storage unit to store data generated by the processor in real time; and
a second storage unit;
wherein the processor checks amount of storage space in use of the first storage unit, compares the current amount of used storage space of the first storage unit checked this time with a previous amount of used storage space of the first storage unit checked previously to determine whether the current amount of used storage space is greater than the previous amount of used storage space, obtains data that was stored in the storage space of the first storage unit since the previous check if the current used storage space is greater than the previously used storage space, and stores the obtained data in the second storage unit after the data is obtained.

2. The electronic device as described in claim 1, wherein 0 is taken as the previous amount of used storage space if the amount of storage space in use of the first storage unit is checked at the first time.

3. The electronic device as described in claim 1, wherein the processor further determines whether the first storage unit is full after the obtained data is stored to the second storage unit and deletes all the data stored in the first storage unit and records the previous used storage space of the first storage unit as 0 if the first storage unit is full.

4. The electronic device as described in claim 1, wherein the data generated by the processor in real time is the system event logs (SEL) which records abnormal states of some elements of the electronic device.

5. The electronic device as described in claim 4, wherein the used storage space of the first storage unit is the number of the SEL stored in the first storage unit.

6. The electronic device as described in claim 1, wherein the electronic device is a server, the processor is a Baseboard Management Controller (BMC).

7. A method for backing up data of an electronic device comprising:
checking amount of storage space in use of a first storage unit;
comparing a current amount of used storage space of the first storage unit checked this time with a previous amount of used storage space of the first storage unit checked previously to determine whether the current amount of used storage space is greater than the previous amount of used storage space;
obtaining data that was stored in the storage space of the first storage unit since the previous check if the current amount of used storage space is greater than the previous amount of used storage space, and
storing the obtained data in a second storage unit after the data is obtained.

8. The method as described in claim 7, wherein 0 is taken as the previous amount of used storage space if the amount of storage space in use of the first storage unit is checked at the first time.

9. The method as described in claim 7, further comprising:
determining whether the first storage unit is full after the obtained data is stored to the second storage unit and deletes all the data stored in the first storage unit; and
recording the previous amount of used storage space to zero if the first storage unit is full.

10. The method as described in claim 7, wherein the data generated by the processor in real time is the system event logs (SEL) which records abnormal states of some elements of the electronic device.

11. The method as described in claim 10, wherein the used storage space of the first storage unit is the number of the SEL stored in the first storage unit.

12. A non-transitory storage medium storing a set of instructions, the set of instructions capable of being executed by a processor to perform a method, the method comprising:
checking amount of storage space in use of a first storage unit;
comparing a current amount of used storage space of the first storage unit checked this time with a previous amount of used storage space of the first storage unit checked previously to determine whether the current amount of used storage space is greater than the previous amount of used storage space;
obtaining data that was stored in the storage space of the first storage unit since the previous check if the current amount of used storage space is greater than the previous amount of used storage space, and
storing the obtained data in a second storage unit after the data is obtained.

13. The non-transitory storage medium as described in claim 12, wherein 0 is taken as the previous amount of used storage space if the amount of storage space in use of the first storage unit is checked at the first time.

14. The non-transitory storage medium as described in claim 12, further comprising:
determining whether the first storage unit is full after the obtained data is stored to the second storage unit and deletes all the data stored in the first storage unit; and
recording previous amount of used storage space of first storage unit to zero if the first storage unit is full.

15. The non-transitory storage medium as described in claim 12, wherein the data generated by the processor real time is the system event logs (SEL) which records abnormal states of some elements of the electronic device.

16. The non-transitory storage medium as described in claim 15, wherein the used storage space of the first storage unit is the number of the SEL stored in the first storage unit.
